(19) United States
(12) Patent Application Publication
(10) Pub. No.: US 2020/0288739 A1
(43) Pub. Date: Sep. 17, 2020

(54) COMPOSITIONS FOR INDUCING A COLOR AND/OR CHEMICAL CHANGE TO A FOODSTUFF AND ASSOCIATED METHODS AND SYSTEMS

(71) Applicant: Raybern Foods, LLC, San Ramon, CA (US)

(72) Inventors: Rhondi Shigemura-Webster, San Ramon, CA (US); Randa Shammet, San Ramon, CA (US)

(21) Appl. No.: 16/891,485

(22) Filed: Jun. 3, 2020

Related U.S. Application Data
(63) Continuation of application No. PCT/US18/64586, filed on Dec. 7, 2018.
(60) Provisional application No. 62/597,065, filed on Dec. 11, 2017.

(51) Int. Cl. A23D 7/00; A23L 33/185; A23L 29/30; A23P 20/10

(52) U.S. Cl. CPC A23D 7/001; A23P 20/11; A23L 29/30; A23L 33/185

(57) ABSTRACT

The present technology is directed generally to compositions for inducing a color and/or chemical and/or physical change to a foodstuff, such as a previously baked bread or other starches and proteins, and associated methods and systems. In some embodiments, the compositions are browning butters and include Maillose™ as a browning agent. Some embodiments further include an additive such as a protein, a reducing sugar, or an alkaline agent.

### CROSS-REFERENCE TO RELATED APPLICATION(S)

This application is a continuation of International Application No. PCT/US18/64586, filed Dec. 7, 2018, entitled “COMPOSITIONS FOR INDUCING A COLOR AND/OR CHEMICAL CHANGE TO A FOODSTUFF, SUCH AS BREAD OR OTHER STARCHES, AND ASSOCIATED METHODS AND SYSTEMS,” and claims the benefit of U.S. Provisional Application No. 62/597,065, filed Dec. 11, 2017, entitled “COMPOSITIONS FOR INDUCING A COLOR AND/OR CHEMICAL CHANGE TO A FOODSTUFF, SUCH AS BREAD OR OTHER STARCHES, AND ASSOCIATED METHODS AND SYSTEMS,” the entirety of both applications being incorporated herein by reference.

### BACKGROUND

Microwaves are being used by consumers to prepare foodstuffs traditionally prepared using other methods and/or devices. However, many consumers would appreciate microwaved foodstuffs that resemble foodstuffs prepared using traditional methods. For example, foodstuffs such as previously baked bread that are subsequently heated in a pan often result in a browned and crisped exterior when prepared with a fat, such as oil or butter. Conversely, applying a fat to previously baked bread and heating in the microwave does not generate a substantially similar browned and/or crisped foodstuff. Therefore, there is a need to develop compositions, methods, and/or systems that can be applied to microwaved foodstuffs and create exterior features similar to those prepared using traditional methods and/or devices.

### BRIEF DESCRIPTION OF THE DRAWINGS

FIG. 1 is a schematic illustration of a foodstuff having a first brown color and a first texture on an external surface of the foodstuff generated using a 100% butter solution

FIG. 2 is a schematic illustration of another foodstuff having a second brown color and a second texture on an external surface of the foodstuff generated using methods in accordance with some embodiments of the present technology, such as heating for about three to about three-and-a-half minutes in a microwave oven of about 1100 watts (W) to about 1200 W.

FIG. 3 is another schematic illustration of yet another foodstuff having a third brown color and a third texture on an external surface of the foodstuff generated using methods in accordance with some embodiments of the present technology, such as heating for about three to about three-and-a-half minutes in a microwave oven of about 1100 W to about 1200 W.

FIG. 4 is yet another schematic illustration of another foodstuff having a fourth brown color and a fourth texture on an external surface of the foodstuff generated using methods in accordance with some embodiments of the present technology, such as heating for about three to about three-and-a-half minutes in a microwave oven of about 1100 W to about 1200 W.

FIG. 5 is yet another schematic illustration of yet another foodstuff having a fifth brown color and a fifth texture on an external surface of the foodstuff generated using methods in accordance with some embodiments of the present technology, such as heating for about three to about three-and-a-half minutes in a microwave oven of about 1100 W to about 1200 W.

FIG. 6 is yet another schematic illustration of another foodstuff having a sixth brown color and a sixth texture on an external surface of the foodstuff generated using methods in accordance with some embodiments of the present technology, such as heating for about three to about three-and-a-half minutes in a microwave oven of about 1100 W to about 1200 W.

FIG. 7 is yet another schematic illustration of yet another foodstuff having a seventh brown color and a seventh texture on an external surface of the foodstuff generated using methods in accordance with some embodiments of the present technology, such as heating for about three to about three-and-a-half minutes in a microwave oven of about 1100 W to about 1200 W.

FIG. 8 is yet another schematic illustration of another foodstuff having an eighth brown color and an eighth texture on an external surface of the foodstuff generated using methods in accordance with some embodiments of the present technology, such as heating for about three to about three-and-a-half minutes in a microwave oven of about 1100 W to about 1200 W.

FIG. 9 is another schematic illustration of another foodstuff having a ninth brown color and a ninth texture on an external surface of the foodstuff generated using methods in accordance with some embodiments of the present technology, such as heating for about three to about three-and-a-half minutes in a microwave oven of about 1100 W to about 1200 W.

FIG. 10 is another schematic illustration of yet another foodstuff having a tenth brown color and a tenth texture on an external surface of the foodstuff generated using methods in accordance with some embodiments of the present technology, such as heating for about three to about three-and-a-half minutes in a microwave oven of about 1100 W to about 1200 W.

FIG. 11 is another schematic illustration of yet another foodstuff having an eleventh brown color and an eleventh texture on an external surface of the foodstuff generated using methods in accordance with some embodiments of the present technology, such as heating for about three to about three-and-a-half minutes in a microwave oven of about 1100 W to about 1200 W.

FIG. 12 is a graph depicting the International Commission on Illumination color space (CIELAB) values quantifying a color on the external surface of foodstuff that was induced by methods in accordance with some embodiments of the present technology.

FIG. 13 is a schematic illustration of a foodstuff having a twelfth brown color and a twelfth texture on an external surface of the foodstuff prepared using a formulation of the present technology.

FIG. 14 is a schematic illustration of a foodstuff having a thirteenth brown color and a thirteenth texture on an external surface of the foodstuff prepared using a formulation of the present technology that includes a whey protein additive.

FIG. 15 is a schematic illustration of a foodstuff having a fourteenth brown color and a fourteenth texture on an external surface of the foodstuff prepared using a formulation of the present technology that includes a soy protein additive.

FIG. 16 is a schematic illustration of a foodstuff having a fifteenth brown color and a fifteenth texture on an external surface of the foodstuff prepared using a formulation of the present technology that includes a dextrose additive.

FIG. 17 is a schematic illustration of a foodstuff having a sixteenth brown color and a sixteenth texture on an external surface of the foodstuff prepared using a formulation of the present technology that includes a d-xylose additive.

FIG. 18 is a schematic illustration of a foodstuff having a seventeenth brown color and a seventeenth texture on an external surface of the foodstuff prepared using a formulation of the present technology that includes a corn syrup additive.

FIG. 19 is a schematic illustration of a foodstuff having an eighteenth brown color and an eighteenth texture on an external surface of the foodstuff prepared using a formulation of the present technology that includes a baking soda additive.

FIG. 20 is another schematic illustration of another foodstuff having a nineteenth brown color and a nineteenth texture on an external surface of the foodstuff prepared using a formulation of the present technology that includes a baking soda additive.

FIG. 21 is a schematic illustration of a foodstuff having a twentieth brown color and a twentieth texture on an external surface of the foodstuff prepared using a formulation of the present technology that includes a tartaric acid additive.

FIG. 22 is a chart depicting viscosities of various formulations of the present technology.

FIG. 23 is another chart depicting viscosities of further formulations of the present technology.

### DETAILED DESCRIPTION

Specific details of some embodiments of the present technology are described below with reference to compositions for inducing a color and/or chemical change to a foodstuff when microwave or other heat is applied to provide an understanding of these embodiments. However, some embodiments can have other components and/or include processes in addition to those described herein. For example, several details describing compositions or processes that are well-known and often associated with compositions for inducing a color and/or chemical change to a foodstuff and associated methods but that may unnecessarily obscure some significant aspects of the disclosure are not set forth in the following description for purposes of clarity. Moreover, although the following disclosure sets forth some embodiments of different aspects of the technology, some embodiments of the technology can have different components, different amounts of components, different methods of use, different methods of formulating, compounding, and/or preparing than those described below. In addition, some embodiments may eliminate particular components and/or methods. A person of ordinary skill in the relevant art, therefore, will understand that the present technology, which includes associated compositions, methods, and systems may also include some embodiments with additional components, amounts thereof, and/or steps, and/or may include some embodiments without several of the components, amounts thereof, and/or steps shown and described below.

Quantities of one or more components in one or more formulations of the present technology are expressed herein as a percent weight of the formulation. As is readily understood by one skilled in the art, adding an additional component to a formulation will change the percent weight values of each of the individual components. The new percent weight values of each component can be easily calculated by one of skill in the art, and such formulations are within the scope of the present technology. The phrase “adding a component at X %” means the component is added at X % of the weight of the formulation before the new component is added, unless otherwise noted. For example, if a component is added at 20% to a 100-gram solution, 20 grams of the component would be added so that the new solution is 120 grams. Certain embodiments may also include descriptions reciting that “once added, the component comprises X % of the formulation.” In these embodiments, X % is the component's percent weight value after it has been added to the formulation. For example, if a component is added to a 100-gram solution so that after being added it is 20% of the solution by weight, 25 grams of the component would be added (so that the new component is 20% of the 125 gram solution).

As used herein, the term “about” means the stated value plus or minus 10%. For example, if a stated value is about 10, the range of values encompassed by “about 10” is 9 to 11.

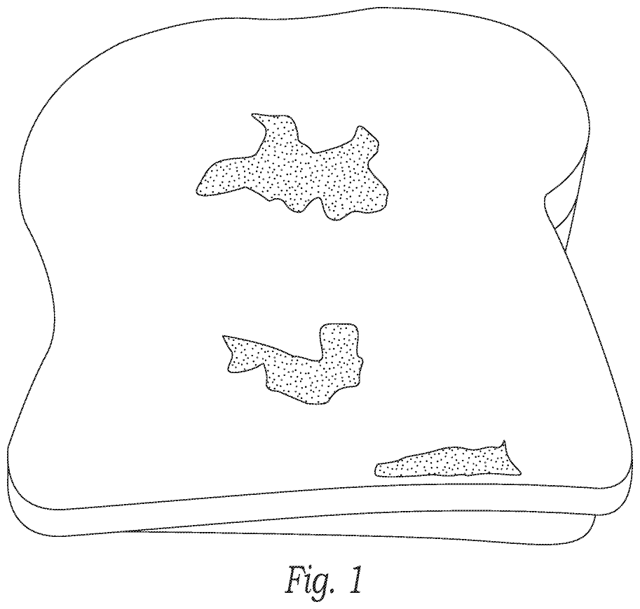

FIG. 1 is a schematic illustration of a foodstuff (e.g., a piece of bread) prepared with a 100% butter solution. The 100% butter solution was applied to the bread, and the bread was heated at 300 degrees Fahrenheit for three minutes. As FIG. 1 illustrates, treating a piece of bread before heating with a 100% butter solution resulted in very little browning after heating and provides a baseline to compare a foodstuff treated with formulations of the present technology and in accordance with the present technology.

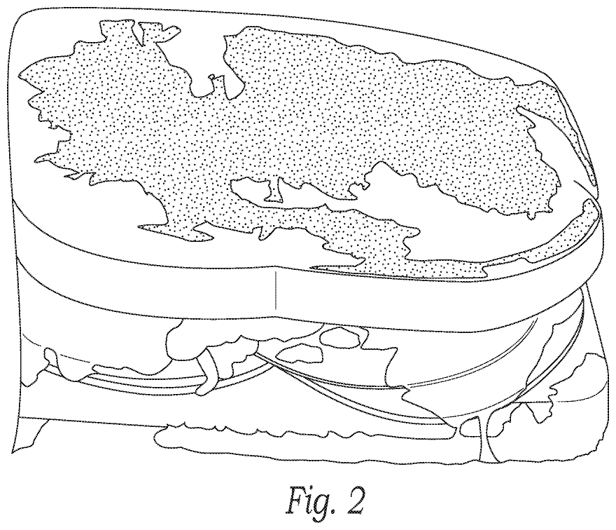

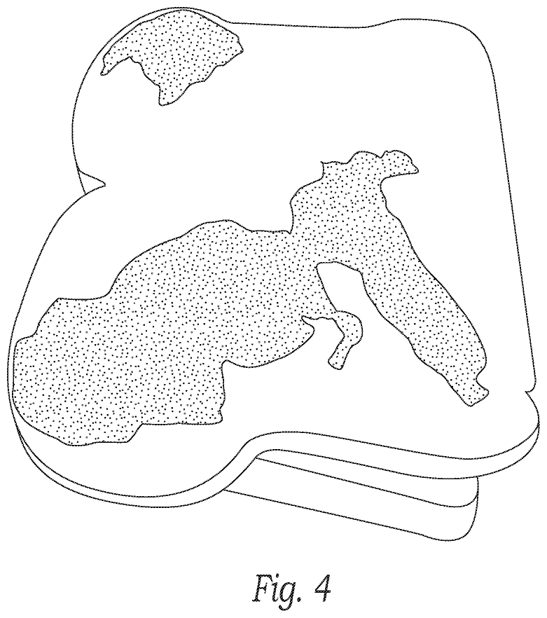

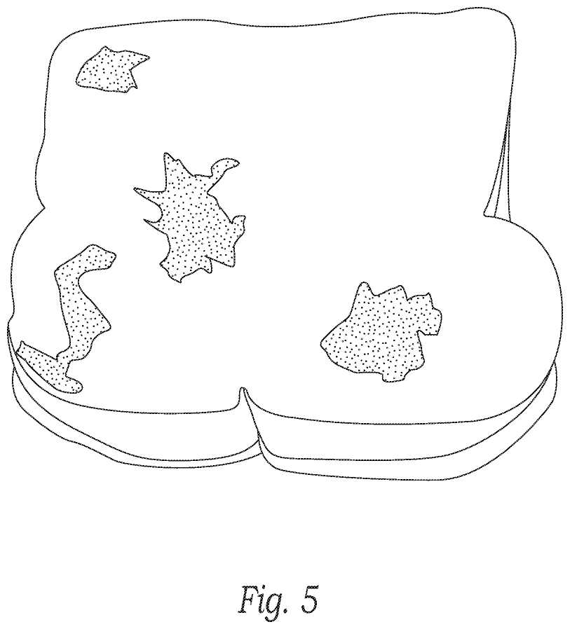

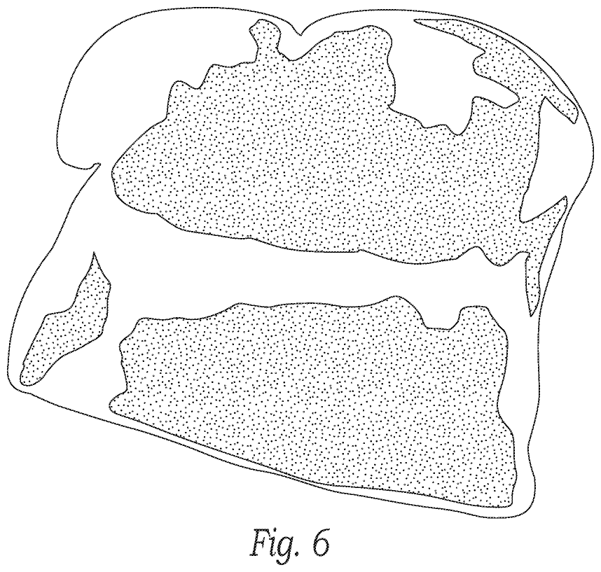

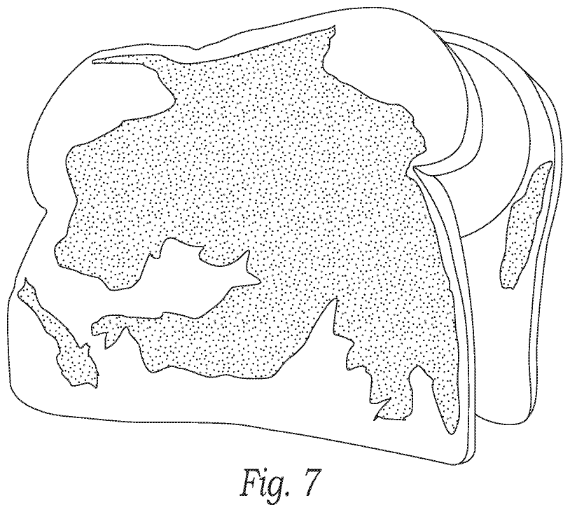

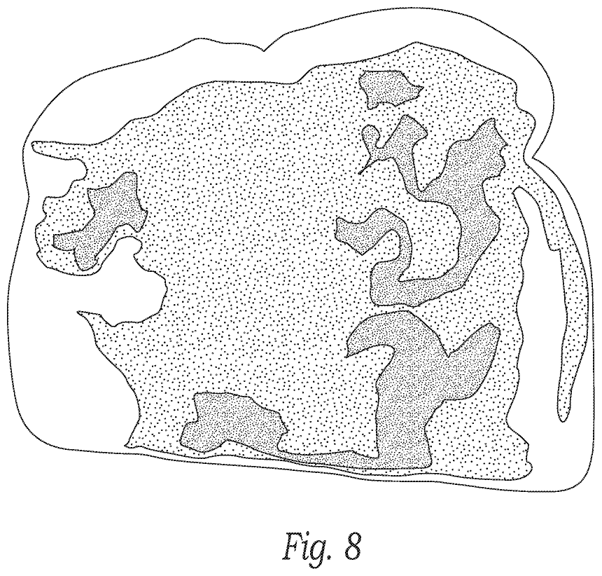

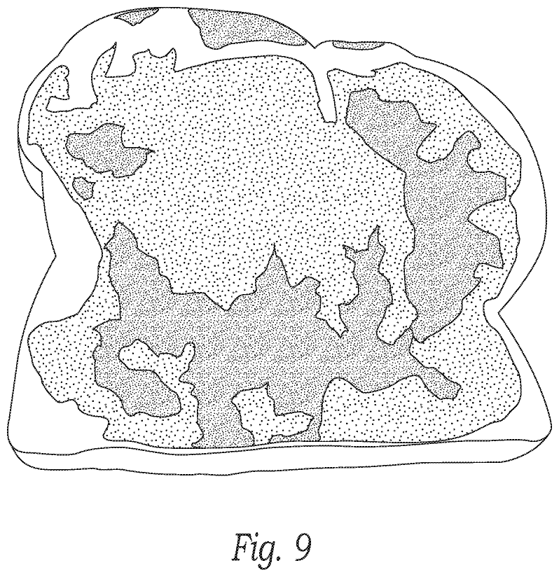

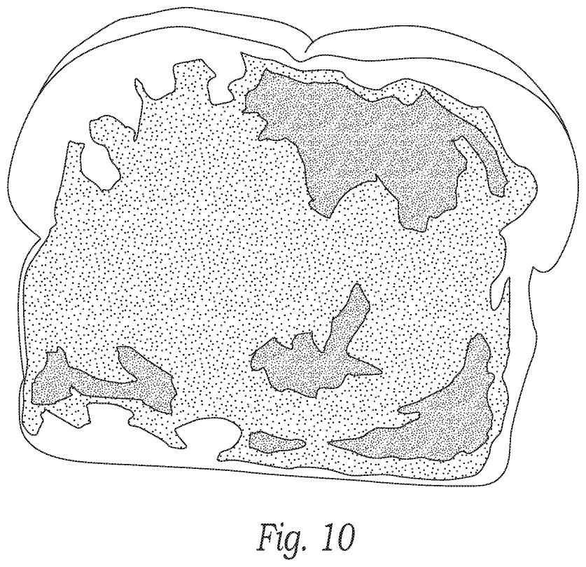

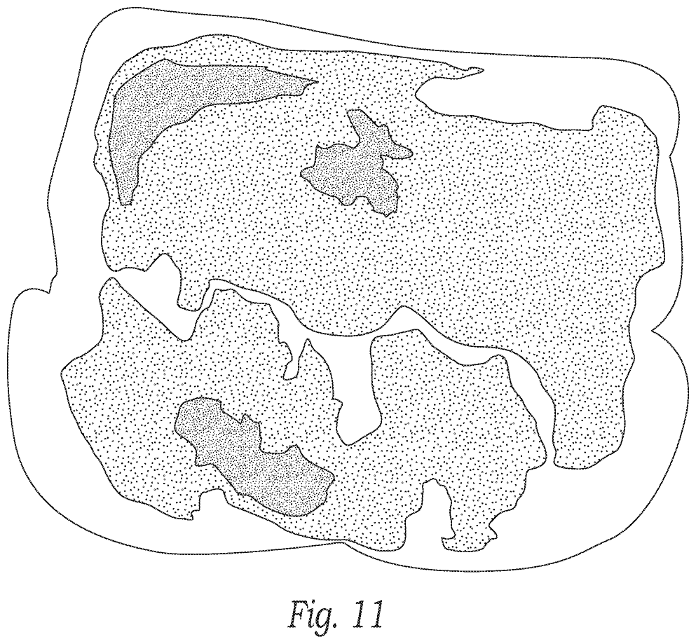

The present technology is directed generally to compositions (e.g., browning butters) for inducing a color, a chemical and/or physical change to a foodstuff, such as a previously baked bread or other starches and proteins, and associated methods and systems. For example, one or more compositions induce an increased browning effect (e.g., a darker or more intense browning as represented by a darker and/or more intense brown color) and/or an increased texture, such as crispiness (e.g., firmer, drier, less-soggy, etc.) to a foodstuff upon application of heat that is greater relative to a baseline (e.g., FIG. 1). In some embodiments, the compositions are browning butters and include Maillose™ as a browning agent. The color and/or chemical change to the baked foodstuff's color is the result of a Maillard reaction. The Maillard reaction occurs between amino acids and reducing sugars. Browning agents emulsified in butter (e.g., browning agents) can have improved flavor compared to browning agents that are not emulsified in butter. For example, a composition of the present technology has been applied to the foodstuffs shown in FIGS. 2-11. The composition is a browning butter having the following components and amounts thereof as provided in Table 1:

TABLE 1
Formulation of a Browning Butter (%
values represent weight/weight)

| | |
|---|---|
| Butter | 73.50% |
| Canola oil | 23.00% |
| Lecithin | 0.50% |
| Maillose | 2.50% |
| Dextrose | 0.50% |
| Whey Protein (optional) | 0.50-5.0% |
| Total | 100% |

As illustrated in FIGS. 2-11, applying the formulation of Table 1 to a foodstuff induces a browning and crisping effect following application of heat. For example, FIGS. 2-11 illustrate a plurality of foodstuffs (e.g., bread of varying thickness, sandwiches of varying thickness, etc.) to which compositions of the present technology may be applied and processed using methods of the present technology, such as heating the foodstuff for between about two and five minutes, inclusive. Without intending to be limiting, the heating can be performed using a microwave oven, such as about a 1100 W to about a 1200 W microwave oven, inclusive. Such heating of foodstuffs to which compositions of the present technology have been applied result in varying degrees of brownness (e.g., a first brown color, a second brown color, etc.) and/or varying degrees of crispness (e.g., a first crispness, a second crispness, etc.).

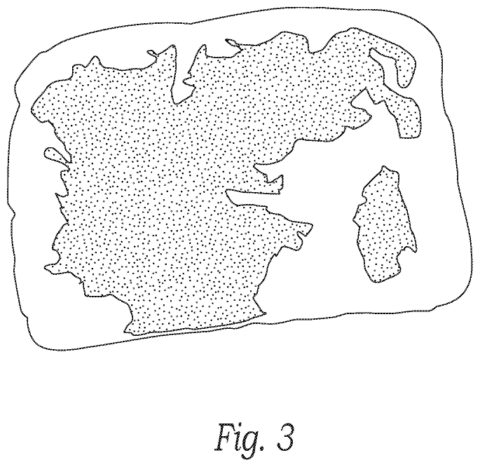

In some embodiments, the first brown color is less intense than the second brown color, which is less intense than the third brown color, which is less intense than the fourth brown color, which is less intense than the fifth brown color, which is less intense than the sixth brown color, which is less intense than the seventh brown color, which is less intense than the eighth brown color, which is less intense than the ninth brown color, which is less intense than the tenth brown color, which is less intense than the eleventh brown color, which is less intense than the twelfth brown color, which is less intense than the thirteenth brown color, which is less intense than the fourteenth brown color, which is less intense than the fifteenth brown color, which is less intense than the sixteenth brown color, which is less intense than the seventeenth brown color, which is less intense than the eighteenth brown color, which is less intense than the nineteenth brown color, or which is less intense than the twentieth brown color. For example, FIG. 2 illustrates a more developed browning effect than seen in FIG. 1. Likewise, FIGS. 3-11 each illustrate a more developed browning effect than seen in FIG. 1. Thus, the formulation of Table 1 induces a more intense browning effect than the foodstuff treated with a 100% butter solution in FIG. 1.

In other embodiments, the first brown color is more intense than the second brown color, which is more intense than the third brown color, which is more intense than the fourth brown color, which is more intense than the fifth brown color, which is more intense than the sixth brown color, which is more intense than the seventh brown color, which is more intense than the eighth brown color, which is more intense than the ninth brown color, which is more intense than the tenth brown color, which is more intense than the eleventh brown color, which is more intense than the twelfth brown color, which is more intense than the thirteenth brown color, which is more intense than the fourteenth brown color, which is more intense than the fifteenth brown color, which is more intense than the sixteenth brown color, which is more intense than the seventeenth brown color, which is more intense than the eighteenth brown color, which is more intense than the nineteenth brown color, or which is more intense than the twentieth brown color.

In some embodiments, the first texture (e.g., crispness) is less firm than the second crispness, which is less firm than the third crispness, which is less firm than the fourth crispness, which is less firm than the fifth crispness, which is less firm than the sixth crispness, which is less firm than the seventh crispness, which is less firm than the eighth crispness, which is less firm than the ninth crispness, which is less firm than the tenth crispness, which is less firm than the eleventh crispness, which is less firm than the twelfth crispness, which is less firm than the thirteenth crispness, which is less firm than the fourteenth crispness, which is less firm than the fifteenth crispness, which is less firm than the sixteenth crispness, which is less firm than the seventeenth crispness, which is less firm than the eighteenth crispness, which is less firm than the nineteenth crispness, or which is less firm than the twentieth crispness.

In other embodiments, the first texture (e.g., crispness) is more firm than the second crispness, which is more firm than the third crispness, which is more firm than the fourth crispness, which is more firm than the fifth crispness, which is more firm than the sixth crispness, which is more firm than the seventh crispness, which is more firm than the eighth crispness, which is more firm than the ninth crispness, which is more firm than the tenth crispness, which is more firm than the eleventh crispness, which is more firm than the twelfth crispness, which is more firm than the thirteenth crispness, which is more firm than the fourteenth crispness, which is more firm than the fifteenth crispness, which is more firm than the sixteenth crispness, which is more firm than the seventeenth crispness, which is more firm than the eighteenth crispness, which is more firm than the nineteenth crispness, or which is more firm than the twentieth crispness.

The present technology also includes formulations comprising the components listed in Table 1 in varying amounts. In certain embodiments, the amounts of each of these components may range, for example, within the ranges prescribed in Table 2 below.

TABLE 2
Formulation of a Browning Butter - Ranges
(% values represent weight/weight)

| | |
|---|---|
| Butter | 70.00-75.00% |
| Canola oil | 20.00-25.00% |
| Lecithin | 0.25-1.00% |
| Maillose | 2.00-3.00% |
| Dextrose | 0.25-1.50% |
| Whey Protein | 0.25%-7.50% |
| Total | values selected from the above |
| | ranges to arrive at 100% |

Other embodiments of the present technology may include formulations comprising the components and amounts listed in Tables 3-9 below:

TABLE 3
Formulation of a Browning Butter (%
values represent weight/weight)

| | |
|---|---|
| Butter | 73.50% |
| Canola oil | 23.5% |
| Lecithin | 0.50% |
| Maillose | 2.50% |
| Total | 100% |

TABLE 4
Formulation of a Browning Butter (%
values represent weight/weight)

| | |
|---|---|
| Butter | 73.00% |
| Canola oil | 23.00% |
| Lecithin | 0.50% |
| Maillose | 2.50% |
| Lye Solution | 1.00% |
| Total | 100% |

TABLE 5
Formulation of a Browning Butter (%
values represent weight/weight)

| | |
|---|---|
| Butter | 72.00% |
| Canola oil | 22.00% |
| Lecithin | 0.50% |
| Maillose | 2.50% |
| Baking Soda | 3.00% |
| Total | 100% |

TABLE 6
Formulation of a Browning Butter (%
values represent weight/weight)

| | |
|---|---|
| Butter | 72.00% |
| Canola oil | 22.00% |
| Lecithin | 0.50% |
| Maillose | 2.50% |
| Lactose | 1.00% |
| Whey Protein | 2.00% |
| Total | 100% |

TABLE 7
Formulation of a Browning Butter (%
values represent weight/weight)

| | |
|---|---|
| Butter | 72.00% |
| Canola oil | 22.00% |
| Lecithin | 0.50% |
| Maillose | 2.50% |
| Corn Syrup | 1.00% |
| Soy Protein | 2.00% |
| Total | 100% |

TABLE 8
Formulation of a Browning Butter (%
values represent weight/weight)

| | |
|---|---|
| Butter | 72.00% |
| Canola oil | 22.00% |
| Lecithin | 0.50% |
| Maillose | 2.50% |
| Baking Soda | 1.00% |
| Corn Syrup | 2.0% |
| Total | 100% |

TABLE 9
Formulation of a Browning Butter (%
values represent weight/weight)

| | |
|---|---|
| Butter | 72.00% |
| Canola oil | 22.00% |
| Lecithin | 0.50% |
| Maillose | 2.50% |
| Baking Soda | 1.00% |
| Lactose | 2.00% |
| Total | 100% |

In addition to the browning butter formulations of Tables 1-9, other compositions of the present technology can include about 60% butter, about 65% butter, about 70% butter, about 75% butter, about 80% butter, about 85% butter, or about 90% butter; about 15% canola oil, about 20% canola oil, about 25% canola oil, or about 30% canola oil; about 0.1% lecithin, about 0.2% lecithin, about 0.3% lecithin, about 0.4% lecithin, about 0.5% lecithin, about 0.6% lecithin, about 0.7% lecithin, about 0.8% lecithin, about 0.9% lecithin, or about 1% lecithin; about 1% Maillose, about 1.5% Maillose, about 2% Maillose, about 2.5% Maillose, about 3% Maillose, about 4% Maillose, or about 5% Maillose; about 0.1% dextrose, about 0.2% dextrose, about 0.3% dextrose, about 0.4% dextrose, about 0.5% dextrose, about 0.6% dextrose, about 0.7% dextrose, about 0.8% dextrose, about 0.9% dextrose, or about 1% dextrose.

As discussed in greater detail below, certain embodiments of the present technology include formulations having an additive that achieves a desired browning or crispness. For example, in some embodiments, the percent of reducing sugar in a formulation is selected to achieve a desired color change (e.g., browning) or intensity thereof, and/or texture (e.g., crisp) change or intensity thereof, based on a desired time to heat the foodstuff, temperature by which to heat the foodstuff, amount of foodstuff to which the formulation has been applied, and/or amount of formulation applied to the foodstuff. In some embodiments, the percent of proteins and/or type of proteins can be selected to achieve desired color change (e.g. browning) and/or texture (e.g., crisping). In some embodiments, the pH of the browning butter can affect the color (e.g. the higher the pH, the increased browning effect) and/or texture (e.g., crisping) of the foodstuff.

Compositions of the present technology can also include one or more components in addition to those listed in Tables 1-9 above, different amounts of one or more of the components listed in Tables 1-9 above, and/or one or more components can be substituted for one or more components listed in Tables 1-9 above. In some embodiments, the additional components can include one or more edible oils, such as canola oil, soybean, or corn oil; one or more emulsifiers, such as monoglycerides, mono-di-glycerides, acids of one or more esters, polyglycerol esters, propylene glycerol esters, sorbitan esters, vegetable based fatty acids, diacetyl tartaric acid ester of mono- and diglycerides (DATEM), and/or polysorbates; one or more sugars, such as sucrose, glucose, maltose, lactose, fructose, xylose, and corn syrup (glucose plus fructose); one or more gums; one or more thickeners; and/or one or more salts or salt crystals of varying shapes and sizes, such as potassium chloride and sodium chloride. In some embodiments, the oil component of the compositions of the present technology can be selected based on a desired viscosity of the compounded composition. Additionally, the one or more gums, one or more thickeners, one or more sugars, and/or one or more salts and/or salt crystals may be selected based on a desired viscosity of the compounded composition. For example, addition of dextrose or an equivalent thereof increases the viscosity of the compounded composition. Additionally, increasing an amount of dextrose or equivalent thereof in the compounded composition further increases the viscosity of the compounded composition. In some embodiments, the salts and/or salt crystals are potassium chloride, sodium chloride, or a combination thereof. A size and/or a shape of the salt crystals may also be selected based on the desired viscosity of the compounded composition. Additionally, the one or more gums, one or more thickeners, or one or more salts or salt crystals may be selected based on a desired viscosity of the compounded composition. The desired viscosity can be the same or different during manufacturing as the compounded composition. In some embodiments, the desired viscosity of the compounded composition and/or desired viscosity during manufacturing is a viscosity suitable for the compounded composition to be consistently applied to the foodstuff by spraying, atomizing, and/or manual and/or machine application by brush, rollers, and/or spreaders. In some embodiments, the emulsifier component of the composition can be selected to form a generally stable emulsion between one or more hydrophobic components (e.g., butter, oil, etc.) and one or more hydrophilic components (e.g., Maillose).

As described previously, the browning of a foodstuff treated with formulations of the present technology occurs due to the Maillard reaction, in which reducing sugars and amino acids react in the presence of heat. Without intending to be limiting, increasing the amount of protein and/or increasing the amount of reducing sugar in a formulation may increase the degree of browning achieved and/or the crispness achieved following the application of heat. In some embodiments, formulations can include an increased protein content, an increased reducing sugar content, or an increase in both protein content and reducing sugar content which is thought to increase the degree of browning achieved and/or the crispness achieved following the application of heat. For example, embodiments with a protein additive may include whey protein (e.g., whey concentrate 80, whey permeate, de-lactosed whey, casein, etc.), soy protein (e.g., soy flour, soy protein isolates, soy protein concentrates, etc.), egg proteins (e.g., liquid eggs, egg yokes, egg whites, whole eggs, etc.), vegetable proteins (e.g., potato protein flour, wheat protein, rice protein, pea protein, lentil protein, chickpea protein, hemp protein, etc.), or other proteins suitable to be added to browning butter formulations. The protein may be added at about 1%, about 2%, about 5%, about 10%, about 15%, about 20%, about 25%, about 30%, or about 35% to any formulation of the present technology. In other embodiments, the protein, once added, may comprise about 1%, about 2%, about 5%, about 10%, about 15%, about 20%, about 25%, about 30%, or about 35% of the formulation.

Examples of reducing sugars that may be added to the formulations of the present technology include, for example, dextrose or dextrose equivalent, xylose, glucose, fructose, lactose, maltose, ribose, galactose, and corn syrup (glucose plus fructose). Reducing sugars may be added at about 1%, about 2%, about 5%, about 10%, about 15%, about 25%, about 30%, or about 35% to any formulation of the present technology. In other embodiments, the reducing sugar, once added, may comprise about 1%, about 2%, about 5%, about 10%, about 15%, about 20%, about 25%, about 30%, or about 35% of the formulation.

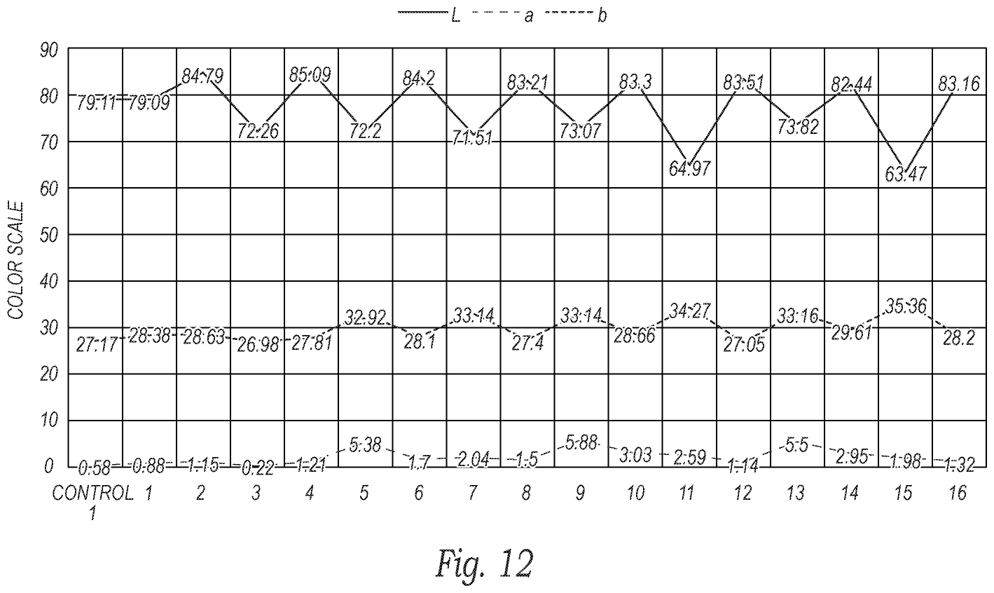

Some embodiments of the present technology may include an increase in both protein content and reducing sugar content. For example, a formulation may include both a protein additive and a reducing sugar additive. Increasing both protein content and reducing sugar content increases the reactants available to undergo the Maillard reaction, and thus may increase the browning effect. In some embodiments, the protein may be added at about 1%, about 2%, about 5%, about 10%, about 15%, about 20%, about 25%, about 30%, or about 35%, and the reducing sugar may be added at about 1%, about 2%, about 5%, about 10%, about 15%, about 20%, about 25%, about 30%, or about 35%. In other embodiments, the sum of the protein and reducing sugar added may be about 1%, about 2%, about 5%, about 10%, about 15%, about 20%, about 25%, about 30%, or about 35%. In other embodiments, the protein, once added, may comprise about 1%, about 2%, about 5%, about 10%, about 15%, about 20%, about 25%, about 30%, or about 35% of the formulation, and the reducing sugar, once added, may comprise about 1%, about 2%, about 5%, about 10%, about 15%, about 20%, about 25%, about 30%, or about 35% of the formulation. In yet other embodiments, the sum of the protein and reducing sugar, once added, may be about 1%, about 2%, about 5%, about 10%, about 15%, about 20%, about 25%, about 30%, or about 35% of the formulation. Various embodiments of formulations including a protein and/or reducing sugar additive are discussed in greater detail below with respect to FIGS. 12-19.

The browning effects of formulations of the present technology can be quantified using a Konica Minolta Benchtop Colorimeter C-5 to measure the CIELAB color space values of the browned foodstuff. There are three measured values in CIELAB: I* for lightness, a* for the green-red color spectrum component, and b* for the blue-yellow color spectrum component. The lightness value, I*, ranges from the darkest black at I*=0 to the brightest white at I*=100. The green-red spectrum component, a*, represents true neutral gray at 0 and runs in the negative direction for green values and the positive direction for red values. The blue-yellow spectrum component, b*, represents true neutral gray at 0 and runs in the negative direction for blue values and the positive direction for yellow values. In certain embodiments of the present technology, the I* value may range from about 60 to about 90, the a* value may range from about 0.1 to about 10, and the b* value may range from about 20 to about 40.

Different embodiments of the present technology may be selected and/or designed to achieve a desired coloring or a specific color space value. For example, the inclusion or exclusion of Maillose from the formulation has an effect on the I*, a*, and b* values achieved. In some embodiments, the formulations including Maillose have I* values ranging from about 75 to about 90, while the formulations without Maillose have I* values ranging from about 55 to about 85. The formulations including Maillose have a* values ranging from about 1 to about 4, while the formulations without Maillose have a* values ranging from about 0.1 to about 7. Finally, the formulations with Maillose have b* values ranging from about 22 to about 33, while the formulations without Maillose have b* values ranging from about 24 to about 38.

Without intending to be bound by any particular theory, another variable that may affect the browning and/or crisping effect of the formulations upon a described herein upon a foodstuff is a pH of the formulation. In some embodiments, altering the pH of the formulation can affect the color and/or texture of foodstuff prepared with the formulation. For example, increasing the pH (e.g., adjusting the formulation to have a basic pH of at least about 8) may increase the browning and/or crisping effect relative to a formulation having a lower pH (e.g., more acidic pH of less than about 7, or a neutral pH in the range of about 7 to about 8). In some embodiments, the pH of the solution will be altered to achieve a desired color or texture, such as, by adding an alkaline or acidic additive. For example, an alkaline additive suitable for human consumption such as sodium hydrogen carbonate (e.g., baking soda) or a lye solution may be added to the formulation to increase the pH of the formulation. The alkaline additive may be added at about 0.1%, about 0.5%, about 1%, about 2%, about 5%, about 10%, about 15%, about 20%, about 25%, about 30%, or about 35%. The alkaline additive may also be added to increase the pH of the formulation by a target amount. For example, the alkaline additive could be added to increase the pH of the formulation by about 0.05, 0.1, 0.25, 0.5, 0.75, 1.0, 1.25, 1.5, 1.75, 2.0, 2.5, 3.0, 3.5 or more. The alkaline may also be added to reach a target pH. For example, the target pH could be about 5.0, about 5.25, about 5.5, about 5.75, about 6.0, about 6.25, about 6.5, about 6.75, about 7.0, about 7.25, about 7.5, about 7.75, about 8.0, about 8.5, or about 9.0. The target pH could also be represented by a range of pH values, such as between 5.0 and 9.0, between 5.5 and 8.0, or between 6.0 and 7.0.

To achieve a desired increase in pH, some embodiments may include a combination of alkaline additives to affect the pH of the formulation. For example, baking soda may be added with a lye solution. In such embodiments, the baking soda and lye solution may be added in an amount effective to raise the pH of the formulation to a target pH discussed herein.

Furthermore, certain embodiments of the present technology may include an acidic additive to reduce the pH of the formulation. For example, an acidic additive such as tartaric acid may be added to the formulation at about 1%, about 2%, about 5%, about 10%, about 15%, about 20%, about 20%, about 25%, about 30%, or about 35%. The acidic additive may also be added to decrease the pH of the formulation by a target amount. For example, the acidic additive could be added to decrease the pH of the formulation by about 0.05, 0.1, 0.25, 0.5, 0.75, 1.0, 1.25, 1.5, 1.75, 2.0, 2.5, 3.0, 3.5 or more. The acidic additive may also be added to reach a target pH. For example, the target pH could be about 5.0, about 5.25, about 5.5, about 5.75, about 6.0, about 6.25, about 6.5, about 6.75, about 7.0, about 7.25, about 7.5, about 7.75, about 8.0, about 8.5, or about 9.0. The target pH could also be represented by a range of pH values, such as between 5.0 and 9.0, between 5.5 and 8.0, or between 6.0 and 7.0.

Without intending to be bound by any particular theory, another variable that may change an effect of formulations of the present technology is the viscosity of the formulations. Viscosity may be altered to affect the color and/or texture of foodstuff prepared with the formulation as well as the ease of use of the formulation. in some embodiments, the viscosity of the formulations is about 50 cP, about 60 cP, about 70 cP, about 80 cP, about 90 cP, about 100 cP, about 120 cP, about 140 cP, about 160 cP, about 180 cP, about 200 cP, about 220 cP, about 240 cP, about 260 cP, about 280 cP, about 300 cP, about 320 cP, about 340 cP, about 360 cP, about 380 cP, about 400 cP, about 420 cP, about 440 cP, about 460 cP, about 480 cP, about 500 cP, about 520 cP, about 540 cP, about 560 cP, about 580 cP, about 600 cP, about 620 cP, about 640 cP, about 660 cP, about 680 cP, about 700 cP, about 720 cP, about 740 cP, about 760 cP, about 780 cP, about 800 cP, about 820 cP, about 840 cP, about 860 cP, about 880 cP, about 900 cP, about 920 cP, about 940 cP, about 960 cP, about 980 cP, about 1000 cP, about 1200 cP, about 1400 cP, about 1600 cP, about 1800 cP, or about 2000 cP. As described above, the desired viscosity can be the same or different during manufacturing as the compounded composition. In some embodiments, the desired viscosity of the compounded composition and/or desired viscosity during manufacturing is a viscosity suitable for the compounded composition to be consistently applied to the foodstuff by spraying, atomizing, and/or manual and/or machine application by brush, rollers, and/or spreaders.

In addition to certain components affecting the viscosity of formulations described herein, temperature may affect the viscosity of the given formulations. Thus, certain embodiments of the present technology include formulations that have a specific viscosity at a given temperature. At room temperature (e.g., between 60 degrees Fahrenheit and 80 degrees Fahrenheit), desired viscosity may be a range between 250 cP and 1000 cP, 300 cP and 900 cP, 400 cP and 800 cP, or 500 cP and 700 cP. In some embodiments, the desired viscosity of the formulation at room temperature may be about 200 cP, about 300 cP, about 400 cP, about 500 cP, about 600 cP, about 700 cP, about 800 cP, about 900 cP, about 1000 cP, or higher.

As stated above, the present technology further includes methods associated with the compositions. These methods can include, but are not limited to, methods of compounding and or using the compositions of the present technology. In some embodiments, the browning butter can be compounded using the following method (1) dissolving the lecithin in the canola oil by mixing with a blender (e.g., hand blender, homogenizer, blending kettle) until the lecithin is substantially incorporated with the canola oil and dissolved therein, (2) melting the butter by exposing the butter to a temperature of about 85° F. to about 110° F., or a temperature of about 90° F. to about 95° F., (3) combining the melted butter with the canola oil/lecithin mixture, (4) emulsifying the butter and butter solids with the canola oil/lecithin mixture by mixing with a blender (e.g., a hand blender, a commercial blender having greater than 50 rounds per minute, a device for agitation, a device for shear, a shaker, a miller, a homogenizer or the like), and (5) emulsifying the Maillose with the canola oil/lecithin/butter mixture by mixing with a blender. If an additional additive is desired, such as a protein, reducing sugar, or alkaline agent, such additive may be mixed with the existing formulation at any step above suitable to create a solution capable of being spread, sprayed, or otherwise applied on foodstuff. In some embodiments, the compounding method stabilizes the composition components such that the browning butter is homogeneous and can be applied to the foodstuff to achieve substantially consistent browning and/or crisping of the foodstuff, such as baked bread. The compounding method can be performed within a desired temperature range to avoid initiating and/or accelerating the Maillard reaction prior to applying the browning butter to the foodstuff. In some embodiments, the desired compounding temperatures are between about 75° F. and about 84° F., inclusive.

In some embodiments, compositions can be applied topically to the foodstuff to induce a color change. The foodstuffs to which the browning butters are applied using methods of the present technology are not pre-grilled or browned using conventional methods, such as grilling, griddling, baking, broiling, and/or infrared heat. As shown in FIGS. 2-11, the foodstuff is a previously baked foodstuff, such as bread (e.g., sliced sandwich bread). In some embodiments, the foodstuff can be other previously baked foodstuffs, such as crusts (e.g., pizza crust, pie crust, quiche crust, encrusted foodstuffs), wraps, pastries, cookies, breadings, coatings, meat protein, or the like. In some embodiments, compositions of the present technology can also be applied to or incorporated within a batter, a marinade, or the like. In some embodiments, compositions of the present technology can also be applied to and/or incorporated within a protein, such as meat. The present technology is not intended to be limited to any of the specific foodstuffs provided herein but can rather be applied to and/or incorporated within any other foodstuffs where inducing the color change (e.g., browning) and/or texture change (e.g., crisping) is desired. As shown in FIGS. 2-11 and 13-21 (described below), the color is generally brown having a plurality of shades, intensities, and saturation levels thereof, although the color change induced by the browning butter is not limited to those shown in these images. The chemical change induced by topically applied browning butters can be enhanced by application of heat. In some embodiments, the browning butters described herein can further induce a change in a texture of the foodstuff. For example, heat can be applied using a microwave, such as a conventional microwave appliance. Following application of microwave heat, the browning butter can cause the exterior surface of the foodstuff to become crisp, rather than soft. FIGS. 2-11 and 13-21 also reflect variations in texture of the foodstuff.

Compositions of the present technology can be applied to foodstuffs using any number of methods suitable for the foodstuff being prepared. For example, sandwiches can be prepared using a line-based process by (1) placing sliced bread on a belt, (2) moving the slices of bread through an atomizer that sprays the browning butter onto the exterior surface of the sliced bread which is initiated by a reader (e.g., photo eye reader) that triggers the atomizer to stop the belt and spray the browning butter, (3) advancing the sprayed bread down the line, (4) flipping the bread such that the sprayed side contacts the belt and the unsprayed side faces the environment, (5) placing sandwich components (e.g., cheese, meat, sauce, etc.) onto the unsprayed side of the bread, (6) placing a sprayed slice of bread onto the components, unsprayed side contacting at least one of the components and the sprayed side facing the environment, (7) wrapping the sandwich with susceptor film, (8) placing the film wrapped sandwich in a carton, and (9) freezing the cartoned sandwiches to a temperature within the range of about −30° F. to about 0° F., or about −20° F. to about 0° F., or about −10° F. to about 0° F.

Foodstuffs to which compositions of the present technology have been applied can be enclosed within a packaging film, such as a flexible susceptor packaging film. In some embodiments, the susceptor packaging film is metalized and includes one or more layers formed from similar and/or different materials. The susceptor packaging film can concentrate heat at the external surface of the foodstuff to enhance the changes induced by the browning butters, such as changing the color and/or the texture (e.g., crisping) of the foodstuff's external surface. In some embodiments, a surface of the susceptor packaging film can be about 100° C., about 120° C., about 130° C., about 140° C., about 150° C., about 160° C., about 170° C., about 180° C., about 190° C., or about 200° C. following the application of heat.

### EXAMPLES

The following examples are illustrative of several embodiments of the present technology.

### Example 1—Color Change Associated with a Maillose Formulation

FIG. 1 is a schematic illustration of a foodstuff (e.g., a piece of bread) prepared with a 100% butter solution. The 100% butter solution was applied to the bread, and the bread was heated at 300 degrees Fahrenheit for three minutes. As FIG. 1 illustrates, treating a piece of bread before heating with a 100% butter solution resulted in very little browning after heating and provides a baseline to compare a foodstuff treated with formulations of the present technology and in accordance with the present technology.

As explained above, the color and/or chemical change to the baked foodstuff's color is the result of a Maillard reaction. The composition is a browning butter having the following components and amounts thereof as provided in Table 1 has been applied to the foodstuffs shown in FIGS. 2-11:

TABLE 1
Formulation of a Browning Butter (%
values represent weight/weight)

| | |
|---|---|
| Butter | 73.50% |
| Canola oil | 23.00% |
| Lecithin | 0.50% |
| Maillose | 2.50% |
| Dextrose | 0.50% |
| Whey Protein (optional) | 0.50-5.0% |
| Total | 100% |

As illustrated in FIGS. 2-11, applying the formulation of Table 1 to a foodstuff (e.g., individual pieces of bread of varying thickness, pieces of bread used to make a sandwich, etc.) induces a browning and crisping effect following application of heat for between about three and about three-and-a-half minutes in about 1100 W to about 1200 W microwave ovens, resulting in varying degrees of brownness and crispiness.

### Example 2—Color Change Associated with Various Maillose Formulations

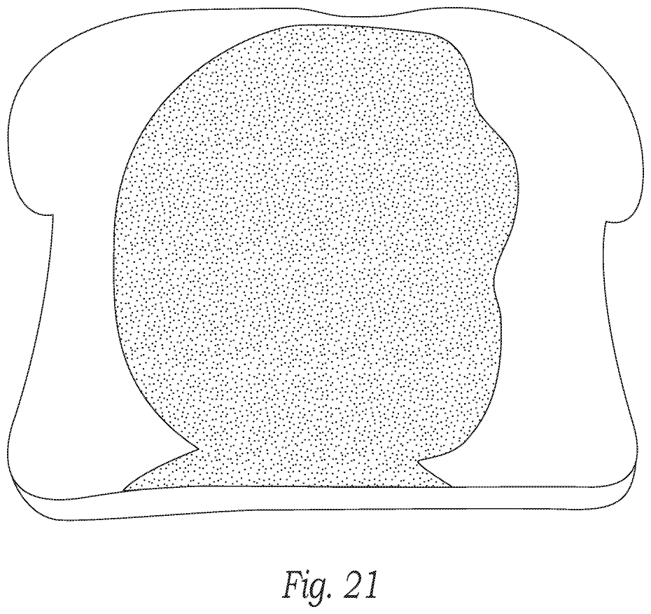

FIG. 12 is a quantitative assessment of the browning effect achieved with seventeen different formulations of the present technology. The formulations each correspond to a number and are described in Table 10 below. The formulations tested that include Maillose comprise about 74% butter, 23% oil, 0.5% lecithin, and 2.5% Maillose. The formulations without Maillose comprise about 75% butter and 25% canola oil, such as 74.6% butter and 25.4% canola oil. The browning effects of the formulations described in Table 10 were quantified using a Konica Minolta Benchtop Colorimeter C-5 to measure the CIELAB color space values of the browned foodstuff. The protein, reducing sugar, and/or alkaline agent listed were each added to the formulation at 20%. The resulting color space values from each of these formulations are depicted in FIG. 21.

TABLE 10
Various Formulations and CIELAB Color Space Values

| | Composition | pH | L | a | b |
|---|---|---|---|---|---|
| Control | Butter/oil | 6.58 | 79.11 | 0.58 | 27.17 |
| | No Maillose | | | | |
| 1 | Butter/oil | 6.53 | 79.09 | 0.88 | 28.38 |
| | No Maillose | | | | |
| | Glucose [Dextrose] | | | | |
| 2 | Butter/oil | 6.54 | 84.79 | 1.15 | 28.63 |
| | Maillose | | | | |
| | Glucose [Dextrose] | | | | |
| 3 | Butter/oil | 6.61 | 72.26 | 0.22 | 26.98 |
| | No Maillose | | | | |
| | D-Xylose | | | | |
| 4 | Butter/oil | 6.55 | 85.09 | 1.21 | 27.81 |
| | Maillose | | | | |
| | D-Xylose | | | | |
| 5 | Butter/oil | 6.35 | 72.2 | 5.38 | 32.92 |
| | No Maillose | | | | |
| | Whey | | | | |
| 6 | Butter/oil | 6.58 | 84.2 | 1.7 | 28.1 |
| | Maillose | | | | |
| | Whey | | | | |
| 7 | Butter/oil | 6.57 | 71.51 | 2.04 | 33.14 |
| | No Maillose | | | | |
| | Soy | | | | |
| 8 | Butter/oil | 6.3 | 83.21 | 1.5 | 27.4 |
| | Maillose | | | | |
| | Soy | | | | |
| 9 | Butter/oil | 6.57 | 73.07 | 5.88 | 33.14 |
| | No Maillose | | | | |
| | Glucose [Dextrose] | | | | |
| | Whey | | | | |
| 10 | Butter/oil | 6.1 | 83.3 | 3.03 | 28.66 |
| | Maillose | | | | |
| | Glucose [Dextrose] | | | | |
| | Whey | | | | |
| 11 | Butter/oil | 6.46 | 64.97 | 2.59 | 34.27 |
| | No Maillose | | | | |
| | Glucose [Dextrose] | | | | |
| | Soy | | | | |
| 12 | Butter/oil | 5.8 | 83.51 | 1.14 | 27.05 |
| | Maillose | | | | |
| | Glucose [Dextrose] | | | | |
| | Soy | | | | |
| 13 | Butter/oil | 6.57 | 73.82 | 5.5 | 33.16 |
| | No Maillose | | | | |
| | D-Xylose | | | | |
| | Whey | | | | |
| 14 | Butter/oil | 5.69 | 82.44 | 2.95 | 29.61 |
| | Maillose | | | | |
| | D-Xylose | | | | |
| | Whey | | | | |
| 15 | Butter/oil | 6.09 | 63.47 | 1.98 | 35.36 |
| | No Maillose | | | | |
| | D-Xylose | | | | |
| | Soy | | | | |
| 16 | Butter/oil | 5.67 | 83.16 | 1.32 | 28.2 |
| | Maillose | | | | |
| | D-Xylose | | | | |
| | Soy | | | | |

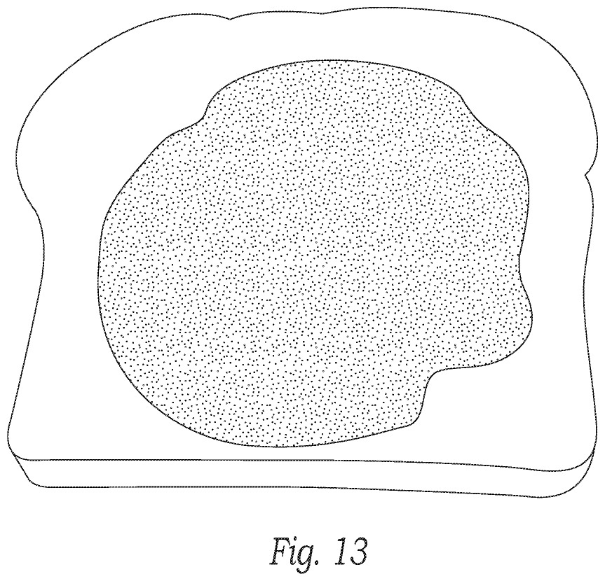

As shown in Table 10, the inclusion or exclusion of Maillose from the formulation has an effect on the I*, a*, and b* values achieved. The formulations including Maillose have I* values ranging from 82.44 to 85.09, while the formulations without Maillose have I* values ranging from 63.47 to 79.11. The formulations including Maillose have a* values ranging from 1.14 to 3.03, while the formulations without Maillose have a* values ranging from 0.22 to 5.88. The formulations with Maillose have b* values ranging from 27.05 to 29.61, while the formulations without Maillose have b* values ranging from 26.98 to 35.36. Thus, including Maillose in the formulation appears to increase the I* value achieved while narrowing the range of a and b values achieved. Other formulations are discussed in greater detail below with respect to FIGS. 13 to 18.

FIG. 13 is a schematic illustration of a piece of bread prepared using the formulation of Table 1 (e.g., the control formulation in Table 10). FIG. 13 provides a baseline with which to compare the browning effects of the protein and/or reducing sugar additive as no protein or reducing sugar additive was added to the formulation. Foodstuffs prepared with the control formulation of Table 10 had a I* value of 79.11, an a* value of 0.58, and a b* value of 27.17.

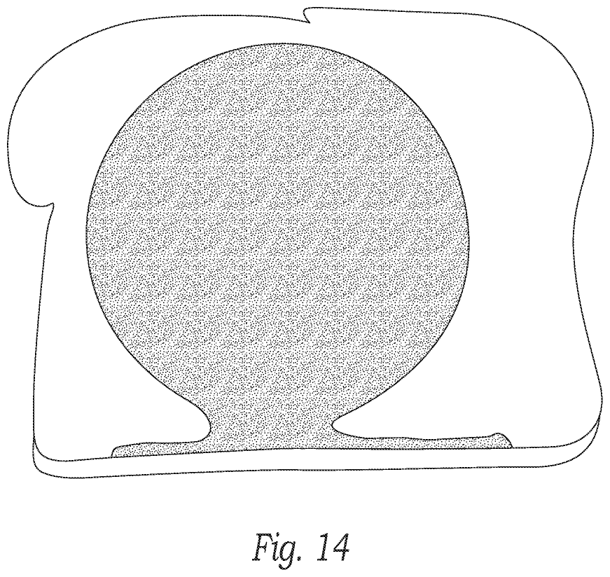

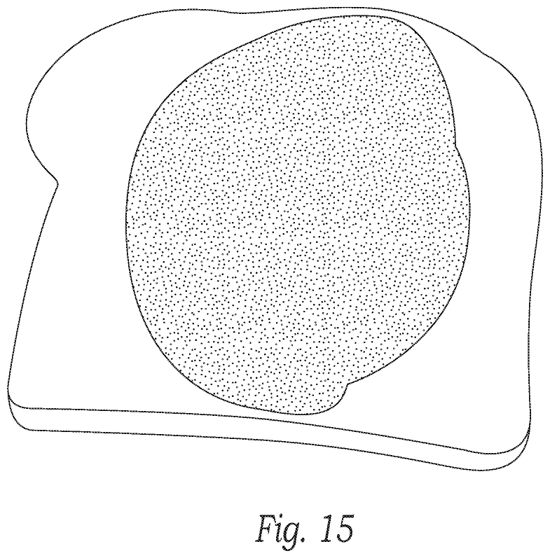

FIGS. 14 and 15 illustrate foodstuffs prepared with formulations of the present technology that include a protein additive. These formulations were applied to bread that was browned at 300 degrees Fahrenheit for two minutes.

FIG. 14 illustrates the browning of bread prepared with a formulation including whey protein added at 20% (e.g., formulation #6 in Table 10). Comparing FIG. 14 to FIG. 13 illustrates that adding 20% whey protein resulted in a darker foodstuff (e.g., more browning occurred) than achieved by the formulation without the whey additive. Foodstuffs prepared with formulation #6 of Table 10 had a I* value of 84.2, an a* value of 1.7, and a b* value of 28.1.

FIG. 15 illustrates the browning of bread prepared with a formulation including adding soy protein at 20% (e.g., formulation #8 in Table 10). Adding 20% soy protein also resulted in a darker foodstuff (indicating more browning) than achieved by the formulation without a protein additive, with a I* value of 83.21, an a* value of 1.5, and a b* value of 27.4.

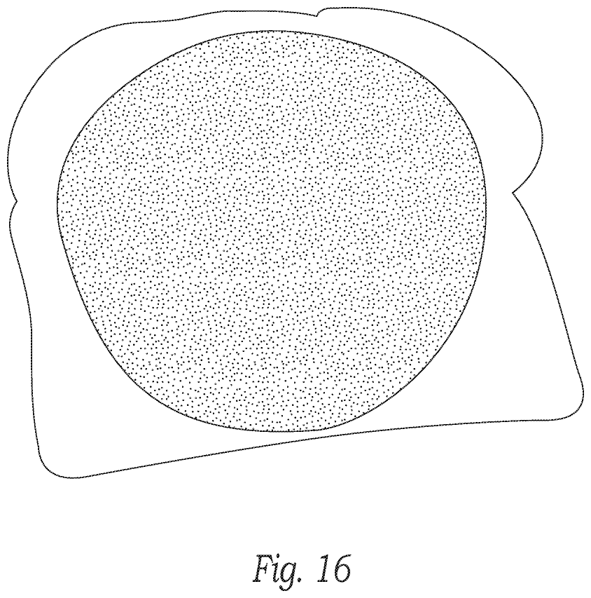

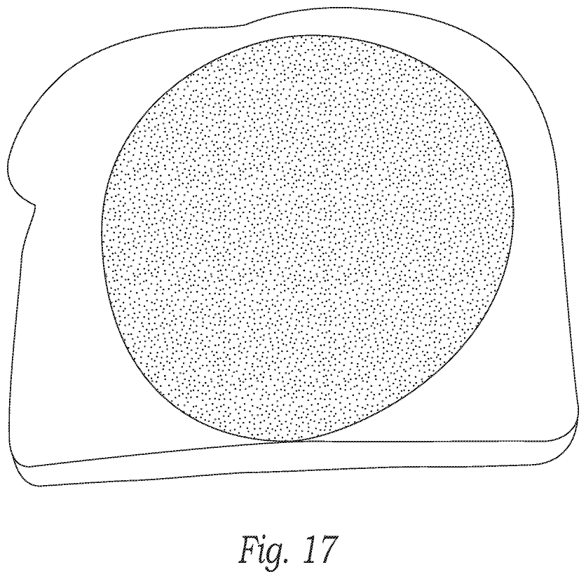

FIGS. 16 and 17 illustrate foodstuffs prepared with formulations of the present technology that include a reducing sugar additive. The various formulations were applied to bread that was browned at 300 degrees Fahrenheit for two minutes.

FIG. 16 illustrates bread browned with a formulation including dextrose added at 20% (e.g., formulation #2 in Table 10, and FIG. 17 illustrates bread browned with a formulation including d-xylose added at 20% (e.g., formulation #4 in Table 10). The formulation with 20% added dextrose had an I* value of 84.79, an a* value of 1.15, and a b* value of 28.63. The formulation with the 20% added d-xylose had an I* value of 85.09, an a* value of 1.21, and a b* value of 28.1. The addition of 20% dextrose and 20% d-xylose did not substantially affect the browning of the bread as compared to FIG. 13. Without intending to be bound by any particular theory, the lack of substantial affect upon browning may be due to the lack of additive protein for the 20% dextrose and 20% d-xylose to react with. It is also thought that the protein component of the formulation increased browning of the foodstuff however, that formulation #4 resulted in a softer texture (e.g., less crisp) which detracted from the overall appearance.

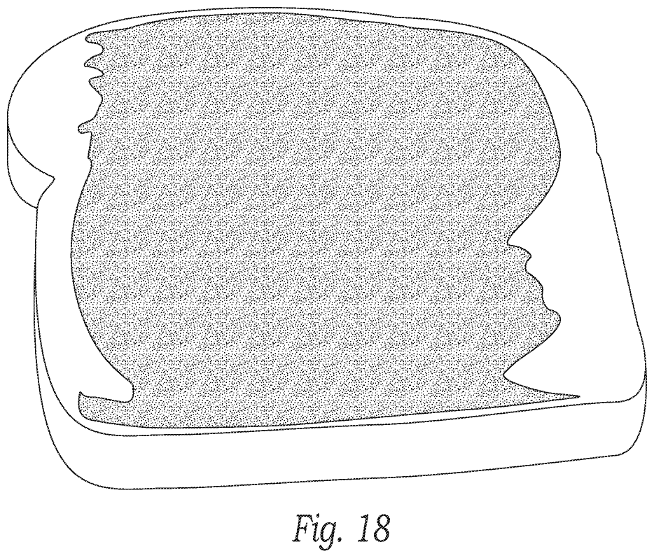

FIG. 18 illustrates another example of bread browned with a formulation including an added reducing sugar. In FIG. 18, corn syrup (glucose plus fructose) was added to the formulation of Table 1 at 25%.

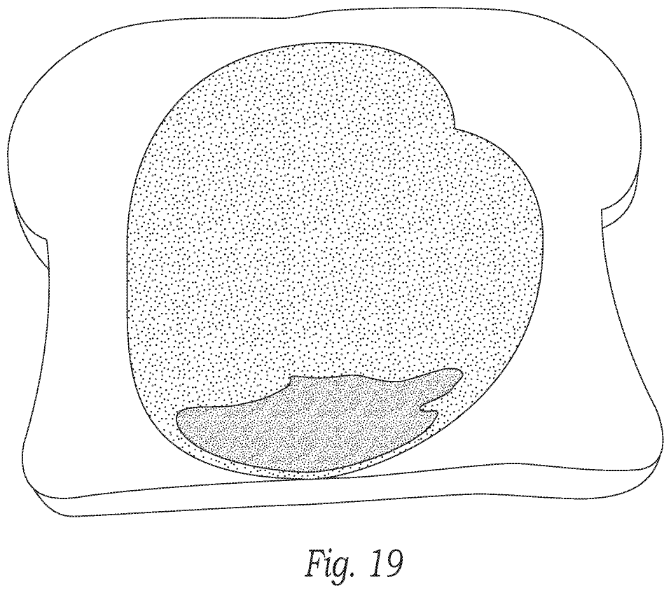

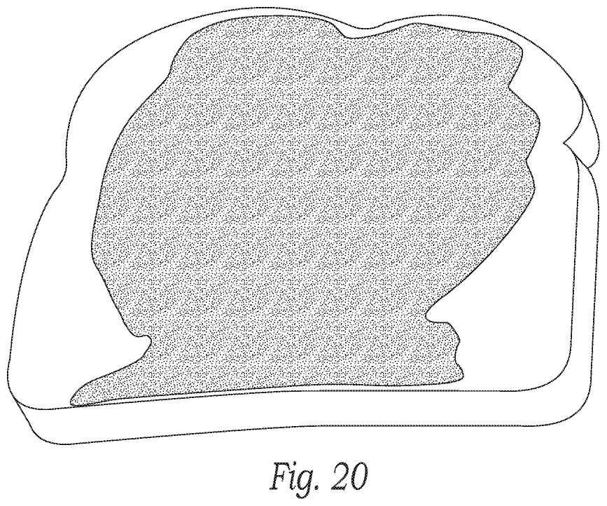

As shown in FIGS. 19 and 20, the addition of baking soda to the formulations increased the browning effect on the foodstuff. FIG. 19 illustrates a foodstuff prepared with a formulation having 20% baking soda to increase the pH of the formulation. FIG. 20 illustrates a foodstuff prepared with a formulation having 25% baking soda to increase the pH of the formulation. Without intending to be limited by any particular theory, the increased browning may be proportional to the amount of baking soda applied, since the addition of 25% baking soda appeared to cause greater browning than the addition of 20% baking soda. Thus, it may be desirable to increase the pH of the formulation by adding an alkaline additive in order to achieve a more intense browning.

FIG. 21 illustrates foodstuff prepared with one embodiment of the present technology that includes the addition of tartaric acid at 20%. As shown in FIG. 21, the addition of an acidic additive did not increase the browning effect on the foodstuff as much as the addition of the alkaline additives.

### Example 3—Viscosities Associated with Various Maillose Formulations

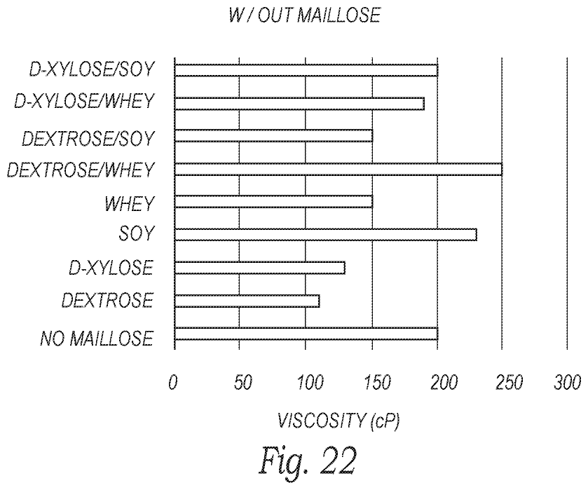

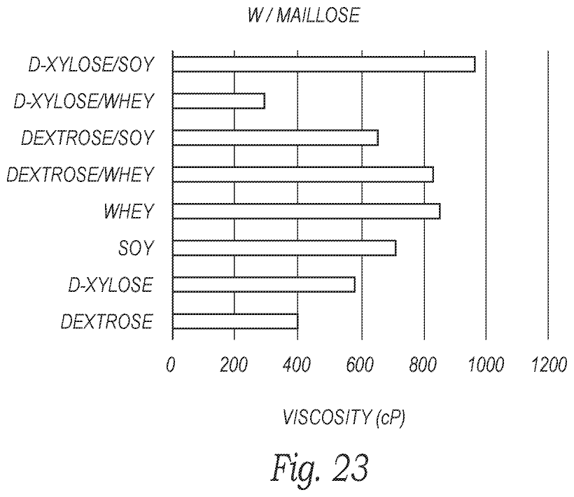

The viscosities of various formulations of the present technology are provided in FIGS. 22 and 23 and Table 11 below. FIG. 22 lists the viscosities of formulations not including Maillose, and FIG. 23 lists the viscosities of formulations including Maillose. The formulations tested that include Maillose comprise about 74% butter, 23% oil, 0.5% lecithin, and 2.5% Maillose. The formulations without Maillose comprise about 75-80% butter, 20-25% oil, and 0.5% lecithin. The protein and/or reducing sugar listed were each added to the formulation at 20%. In general, adding Maillose significantly increased the viscosity of the formulations. The increase, however, was not equal across the different formulations. For example, adding Maillose to a formulation comprising butter, oil, d-xylose, and soy raised the viscosity from 200 cP to 960 cP, whereas adding Maillose to a formulation comprising butter, oil, d-xylose, and whey only raised the viscosity from 190 cP to 290 cP. The specific viscosities of certain formulations with and without Maillose are reflected in Table 11 below (and correspond to FIGS. 22 and 23).

TABLE 11
Viscosity of Various Formulations with and without Maillose

| | |
|---|---|
| Composition | 20 rpm |

without Maillose

| | |
|---|---|
| No Maillose | 200 |
| Dextrose | 110 |
| D-Xylose | 130 |
| Soy | 230 |
| Whey | 150 |
| Dextrose/Whey | 250 |
| Dextrose/Soy | 150 |
| D-Xylose/Whey | 190 |
| D-Xylose/Soy | 200 |

with Maillose

| | |
|---|---|
| Dextrose | 400 |
| D-Xylose | 580 |
| Soy | 710 |
| Whey | 850 |
| Dextrose/Whey | 830 |
| Dextrose/Soy | 650 |
| D-Xylose/Whey | 290 |
| D-Xylose/Soy | 960 |

From the foregoing, it will be appreciated that some embodiments of the presently disclosed technology have been described herein for purposes of illustration, but various modifications may be made without deviating from the disclosed technology. For example, the compositions, methods, and/or systems can differ from those specifically described above. Moreover, certain aspects of the technology described in the context of some embodiments may be combined or eliminated in some embodiments. While advantages associated with some embodiments of the disclosed technology have been described in the context of those embodiments, not all embodiments need necessarily exhibit such advantages to fall within the scope of the present technology.

We claim:

1. A composition comprising about 73.50% butter, 23.00% canola oil, 0.50% lecithin, 2.50% Maillose, and 0.50% dextrose.

2. The composition of claim 1, further comprising a whey protein added at about 1%, about 2%, about 5%, about 10%, about 20%, about 25%, about 30%, or about 35%.

3. The composition of claim 1, further comprising a soy protein added at about 1%, about 2%, about 5%, about 10%, about 15%, about 20%, about 25%, about 30%, or about 35%.

4. The composition of claim 1, further a reducing sugar added at about 1%, about 2%, about 5%, about 10%, about 15%, about 20%, about 25%, about 30%, or about 35%.

5. The composition of claim 1, further comprising a protein added at about 1%, about 2%, about 5%, about 10%, about 20%, about 25%, about 30%, or about 35%, and further comprising a reducing sugar added at about 1%, about 2%, about 5%, about 10%, about 20%, about 25%, about 30%, or about 35%.

6. The composition of claim 5, wherein the reducing sugar is selected from one or more of dextrose, xylose, glucose, fructose, lactose, maltose, ribose, galactose, and corn syrup.

7. The composition of claim 5, wherein the protein is whey protein, soy protein, or a combination thereof.

8. The composition of claim 1, further comprising an alkaline additive added at about 1%, about 2%, about 5%, about 10%, about 20%, about 25%, about 30%, or about 35%.

9. The composition of claim 8, wherein the alkaline additive is added in an amount sufficient to make a pH of the composition about 5.0, about 5.5, about 6.0, about 6.5, about 7.0, about 7.5, about 8.0, about 8.5, or about 9.0.

10. The composition of claim 9, wherein the alkaline additive is baking soda, a lye solution, or a combination thereof.

11. A composition comprising from about 54.50% butter to about 73% butter, from about 17% canola oil to about 22.5% canola oil, about 0.40% lecithin to about 0.50% lecithin, about 1.9% Maillose to about 2.50% Maillose, and about 0.4% dextrose to about 0.50% dextrose.

12. The composition of claim 11, further comprising about 1% protein to about 25.8% protein.

13. The composition of claim 12, wherein the protein is whey protein, soy protein, or a combination thereof.

14. The composition of claim 11, further comprising about 1% reducing sugar to about 25.8% reducing sugar.

15. The composition of claim 14, wherein the reducing sugar is selected from one or more of dextrose, xylose, glucose, fructose, lactose, maltose, ribose, galactose, and corn syrup.

16. The composition of claim 11, further comprising about 1% alkaline additive to about 25.8% alkaline additive.

17. The composition of claim 16, wherein the alkaline additive is baking soda, a lye solution, or a combination thereof.

18. The composition of claim 1, wherein the composition is formulated for application to a foodstuff and, when applied to the foodstuff, the composition increases a browning of the foodstuff in the presence of heat compared to a browning in the absence of the composition.

19. The composition of claim 11, wherein the composition is formulated for application to a foodstuff and, when applied to the foodstuff, the composition increases a browning of the foodstuff in the presence of heat compared to a browning in the absence of the composition.

20. A method of making the composition of claim 11, comprising:
dissolving the lecithin in the canola oil by mixing with a blender until the lecithin is substantially incorporated with the canola oil and dissolved therein;
melting the butter by exposing the butter to a temperature of about 85° F. to about 110° F., or a temperature of about 90° F. to about 95° F.;
combining the melted butter with the canola oil/lecithin mixture;
emulsifying the butter and butter solids with the canola oil/lecithin mixture by mixing with a blender; and
emulsifying the Maillose with the canola oil/lecithin/butter mixture by mixing with a blender.
